(19) United States
(12) Patent Application Publication
(10) Pub. No.: US 2006/0185796 A1
(43) Pub. Date: Aug. 24, 2006

(54) Laminating apparatus

(75) Inventors: Takuya Hayasaka, Tokyo (JP); Katsuhide Tsukamoto, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: LINTEC CORPORATION, Itabashi-ku (JP)

(21) Appl. No.: 11/343,220

(22) Filed: Jan. 31, 2006

Related U.S. Application Data
(63) Continuation-in-part of application No. 10/682,068, filed on Oct. 10, 2003, now abandoned.

(30) Foreign Application Priority Data
Oct. 11, 2002 (JP) 2002-298535

(51) Int. Cl. B32B 37/00; B32B 38/04; B32B 38/10

(52) U.S. Cl. 156/361; 156/521; 156/538; 156/540; 156/542; 156/556

(57) ABSTRACT

Using a strip material carrying a film for forming a label to a base sheet, cuts are formed in the film at a by a cutting means while feeding the strip material, and film areas excluding labels are collected. The labels are left on the base sheet and, after being peeled off at a peeling means, the label is sucked and held by the label holding member. The label is subsequently transferred to a recording substrate at a laminating position and is laminated onto a recording substrate while being pressed by a press roller. The strip material is motivated by a motor. A dancer roller disposed between the cutting means and the peeling means removes slack in the strip material, and a motor controller controls the speed of the motor based on the sensed position of the dancer roller.

This application is a continuation-in-part of application Ser. No. 10/682,068, which was filed on Oct. 10, 2003.

### DESCRIPTION OF THE INVENTION

### BACKGROUND OF THE INVENTION

1. Field of the Invention

The present invention relates to a laminating apparatus, and particularly, to a laminating apparatus suitable for laminating a film onto a surface of a recording layer formed on one side of an optical disk, which serves as an information recording medium.

2. Description of the Related Art

Conventionally, an optical disk capable of storing and reproducing high volume information is formed with a recording layer on one side thereof and a light transmissible film is laminated to protect the recording layer. The lamination of the film is made using a master roll constituted by winding a strip material comprising a base sheet made of a consecutively extending release sheet or the like and protective labels laminated on one side of the base sheet at predetermined intervals. It is arranged so that the master roll is held by a feeding means disposed at the upstream side of a label laminating means, and in the process the strip material is fed out, the feeding direction of the strip material is sharply changed, thereby the protective label is peeled off from the base sheet, and then, the peeled protective label is laminated onto the recording substrate.

However, in the conventional laminating apparatus, since it is structured so that the protective label previously formed into a shape of the optical disk is fed out from a state that the same is wound along with the base sheet into a roll, generally a line mark made by winding resides in the protective label causing decrease in quality or lamination failure of the protective label. That is, since the protective labels are wound into a roll in a state being applied onto the base sheet interposed with an adhesive, they are wound in a state that the same on each layer along the direction of the diameter of the roll are not always precisely overlapped on each other. Accordingly, due to the elastic deformation of the adhesive and the edges of the protective labels overlapped with each other, pressed trace (step) or pressed damage caused by the winding pressure is formed on the surface of the protective label resulting in a decrease of the surface accuracy of the protective label. When the protective label having such pressed trace or pressed damage is laminated onto the optical disk, it may cause a considerably adverse effect on recording or reproducing. Furthermore, since the manufacturing process of the protective label and the laminating process of the protective label are separated from each other, such inconvenience that the manufacturing efficiency of the optical disk itself is also decreased is resulted in.

### SUMMARY OF THE INVENTION

The present invention has been proposed in view of the problems. An object of the invention is to provide a laminating apparatus capable of inhibiting decrease in surface accuracy of the label by forming a label in the process of feeding out of the strip material, and by laminating the label immediately after being formed onto a disk-like information recording substrate to avoid effectively the conventional lamination failure caused from the line mark made by winding.

Another object of the invention is to provide a laminating apparatus with versatility, which achieves the manufacturing of the label and the manufacturing of the recording substrate laminated with the label with a single unit; thereby the manufacturing efficiency can be significantly improved resulting in a reduction of the manufacturing cost as well as the surface accuracy of the protective label can be prevented from being decreased.

In order to achieve the object, the invention adopts such structure that a laminating apparatus for laminating a label on the recording layer surface of a disk-like information recording substrate comprises a feeding means for feeding a strip material applied with a film for forming a label on a base sheet, a pre-cutting means for forming a label by making cuts on the film in accordance with the plane shape of the recording substrate, a peeling means for peeling the label from the base sheet, and a label laminating means for laminating the peeled label to the recording substrate. In the structure, the strip material is constituted in a state that the film for forming the label is applied to the base sheet, and the strip material wound into a roll-like shape is consecutively fed out from the feeding means. The fed out strip material is formed with cuts into a plane shape corresponding to the shape of the recording substrate by the pre-cutting means at a position on its way. The cuts include an outer circular cut corresponding to the outer shape of the recording substrate and an inner circular cut corresponding to the central portion of the recording substrate. The outer circular cut is formed in the film and the inner circular cut is formed in both of the film and the base sheet. The label formed by the pre-cutting means is, after being peeled off via the peeling means, laminated onto the recording substrate by the label laminating means. Thus, since the label is formed from a master roll of the strip material, and is consecutively laminated onto the recording substrate in the next process after being formed, it is made possible to reliably eliminate the problems of the conventional apparatus, in which the label previously applied on the base sheet at predetermined intervals is fed out from a roll-like master roll and laminated onto the recording substrate after being peeled off therefrom.

In the invention, it is preferred that the laminating apparatus further includes collecting means for collecting film area excluding the label. Here, the collecting means may comprise a first collection unit for collecting the outer film area positioned at the outer side of the label and a second collection unit for collecting the inner film area formed at the central area of the label.

Further, the second collection unit of the invention comprises a blowing means for blowing air to the inner film area, and a suction means for sucking the inner film area positioned at the opposite side of the blowing means. Owing to this structure, since the second collection unit can collect the inner film area without coming into contact therewith, the collection can be achieved reliably without requiring stopping operation or reducing the laminating efficiency.

The label laminating means comprises a stage that supplies the recording substrate to a predetermined laminating position, a label holding member that is provided movably with respect to the recording substrate at the laminating position and holds the label, and a pressing member that gives a predetermined pressing force to the label overlapped over the recording layer surface of the recording substrate by relative movement between the recording substrate and the label holding member. Owing to this arrangement, the label can be laminated with a specific pressing force when the label is laminated onto the recording substrate, and the laminating accuracy can be maintained satisfactorily.

Further, the laminating apparatus is arranged so that the label holding member is provided so as to perform a relative movement with respect to the surface of the recording substrate while holding the label in an inclined posture with respect to the surface of the recording substrate, and that the pressing member presses the label while moving from one end to the another end thereof to laminate the label onto the recording substrate sequentially. Here, the pressing member may comprise a roller capable of rotating on the label. Owing to this arrangement, it is possible to laminate the label while expelling air residing between the label and the recording substrate preventing the air bubble being caught therebetween.

Still further, the laminating apparatus includes a configuration in which the movement of the strip material and the rotation of the pre-cutting means is motivated by a motor. A dancer roller disposed between the pre-cutting means and the peeling means removes slack in the strip material, and a motor controller controls the speed of the motor based on the sensed position of the dancer roller.

In this specification, the term “label” includes not only a protective label, which is laminated to protect the recording layer and the like of the disk but also label or sheet and the like for forming a information recording pit utilizing energy-ray hardening.

### BRIEF DESCRIPTION OF THE DRAWINGS

FIG. 1 is an elevation schematically showing a laminating apparatus according to one embodiment,

FIG. 2 is a perspective view schematically showing a part of the constitution shown in FIG. 1 of which layout is partially changed,

FIG. 3 is an enlarged elevation of a laminating means,

FIG. 4 is a schematic plan view of the stage side supporting recording substrates, and

FIG. 5 is an elevation schematically showing a detail of a control system of the laminating apparatus of the present invention.

### DETAILED DESCRIPTION OF THE PREFERRED EMBODIMENT

Now, one embodiment of the present invention will be described below with reference to the attaching drawings.

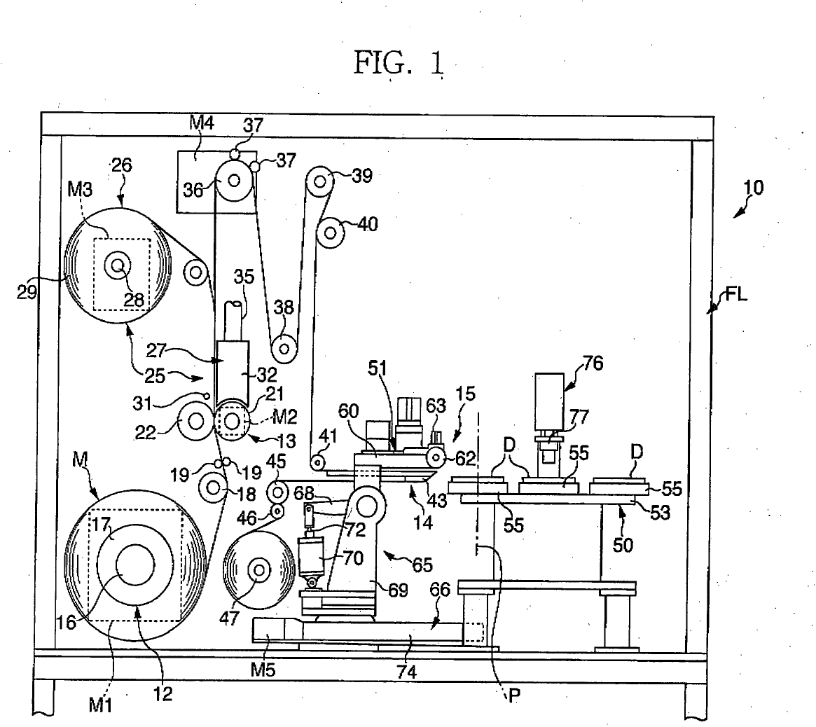

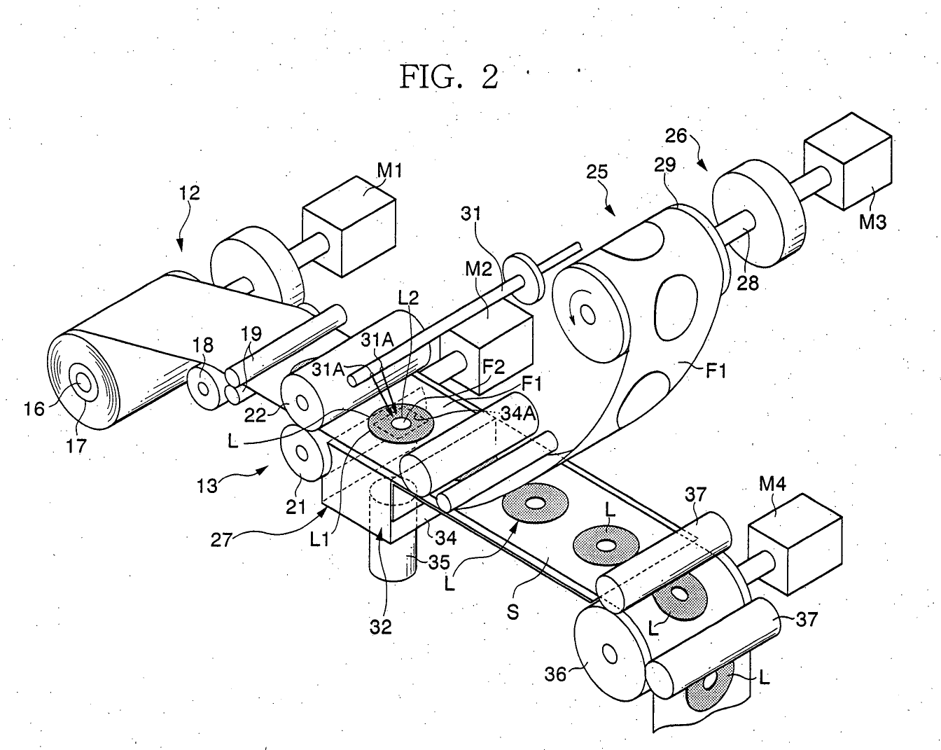

FIG. 1 is a view schematically showing the structure of a laminating apparatus according to the embodiment. FIG. 2 is a perspective view schematically showing a part of component parts shown in FIG. 1, of which layout is changed for the convenience of the description. Referring to these drawings, a laminating apparatus 10 is structured so as to be roughly received within a frame FL defining the outer shape of the apparatus. Provided in the frame FL are a feeding means 12 disposed to feed a strip material M wound into a roll-like shape, a pre-cutting means 13 for forming a predetermined cut in the strip material M fed out from the feeding means 12, a peeling means 14 for peeling a protective label L (refer to FIG. 2) formed by the pre-cutting means 13 from a base sheet S, and a label laminating means 15 for laminating the peeled protective label L to an optical disk D.

The strip material M comprises a film F for forming protective label, which is laminated being interposed with adhesive on one surface of a base sheet S which serves as a release sheet. The strip material M is supported by the feeding means 12 in a state being wound into a roll-like shape to be fed out in order therefrom.

The feeding means 12 comprises a motor M1 and a rotation axis 16 coupled with the motor M1, and it is arranged so that a winding core 17 of the strip material M is inserted by the rotation axis 16 therethrough around the outer periphery of the axis. The strip material M fed from the feeding means 12 is sent to the pre-cutting means 13 through the guide roller 18 and a pair of static eliminating bars 19 disposed opposing each other to allow the strip material M to go therethrough for eliminating static charge from the strip material M.

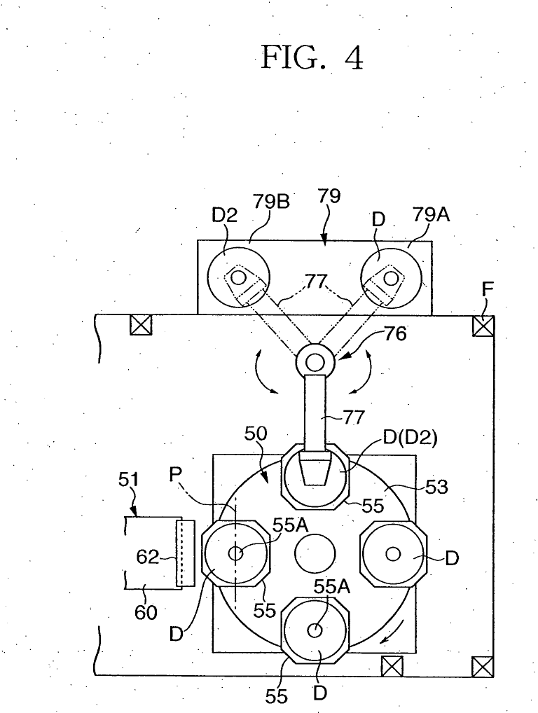

The pre-cutting means 13 comprises a die receive roll 21 rotatable by a motor M2 and a die-cut roll 22 disposed opposing the die receive roll 21 to pinch the strip material M by interacting with the die receive roll 21. On the outer periphery of the die-cut roll 22, a cutter blade (not shown) has been formed, and by rotation of the die-cut roll 22, an outer cut L1 and an inner cut L2 are formed concentrically within the surface of the strip material M corresponding to the shape of the flat surface of the recording substrate D (refer to FIG. 4). The film area between the outer cut L1 and the inner cut L2 becomes the protective label L; and the periphery side of the protective label L becomes an outer film area F1, and the inner side of the inner cut L2 formed in the central area of the protective label L becomes an inner film area F2. Here, the outer cut L1 is formed in the film F and the inner cut L2 is formed in both of the film F and the base sheet S. Thereby, the protective label L having a roughly doughnut-like shape is left on the base sheet S to be sent toward the downstream side along with the base sheet S, and thus, the outer film area F1 and the inner film area F2 can be collected by a collecting means 25.

The collecting means 25 comprises a first collection unit 26 for collecting the outer film area F1 and a second collection unit 27 for collecting the inner film area F2. The first collection unit 26 comprises a motor M3 and a winding drum 29 supported around an output shaft 28 of the motor M3. It is arranged so that the outer film area F1 can be collected in order as a trimming residue by the rotation of the motor M3.

The second collection unit 27 is disposed adjacent to the die-cut roll 22, and comprises a pipe-like member 31 as a blowing means extending in the width direction of the strip material M and a suction means 32 positioned at the opposite side of the pipe-like member 31 being interposed by the strip material M. Formed at two points along the axial direction of the pipe-like member 31 are nozzle holes 31A and it is arranged so that the air blown out from the nozzle holes 31A is blown to the inner film area F2. On the other hand, the suction means 32 comprises a box member 34 positioned along the lower surface of the strip material M shown in FIG. 2, and a vacuum pipe 35 for depressurizing the inside of the box member 34. Formed at the upper side of the box member 34 is a suction hole 34A being a little larger than the plan area of the inner film area F2, and the inner film area F2 can be collected into the box member 34 through the suction hole 34A. Thereby the strip material M is sent in order toward the peeling means 14 by a drive roller 36 disposed at the upstream side of the peeling means 15 in a state that the protective label L is left on the base sheet S.

The drive roller 36 is fixed to the output shaft of the motor M4, and at two points of the outer periphery thereof, pinch rollers 37, 37 are disposed. The base sheet S and the protective label L sent out by the drive roller 36 are sent to the peeling means 14 through a dancer roller 38 constituting a slacking mechanism and guide rollers 39, 40 and 41 disposed at the downstream side thereof.

According to the embodiment, the peeling means 14 comprises a peel plate 43 fixed to the frame FL. That is, the base sheet S and the protective label L is wrapped so as to turn sharply at the front end of the peel plate 43 (right end in FIG. 1), and it is arranged so that the protective label L can be peeled off forward in an approximately horizontal plane (right side in FIG. 1) at the front edge position of the peel plate 43. The lead end of the base sheet S is fixed to a winding core of a winding drum 47 fixed to the output shaft of a motor (not shown) through guide rollers 45 and 46. The protective label L thus peeled is laminated onto the recording surface side of the recording substrate D by the label laminating means 15.

The label laminating means 15 comprises a stage 50 for supporting recording substrate D and a label holding member 51 provided so as to perform a relative movement with respect to the recording substrate D at the laminating center position P (refer to FIG. 1). As shown also in FIG. 4, the stage 50 comprises a turntable 53 provided rotatably within a plane and holding tables 55, which are disposed being spaced from each other by approximately 90 degrees in the periphery direction of the turntable 53 and is capable of placing a recording substrate D respectively on the upper side thereof. At the center of each holding table 55, a centering hole 55A (refer to FIG. 4) is formed, and to the centering hole 55A, a chick (not shown) is provided so as to come out and go out in the vertical direction. It is arranged to perform centering of the recording substrate D on the holding table 55 by the chuck.

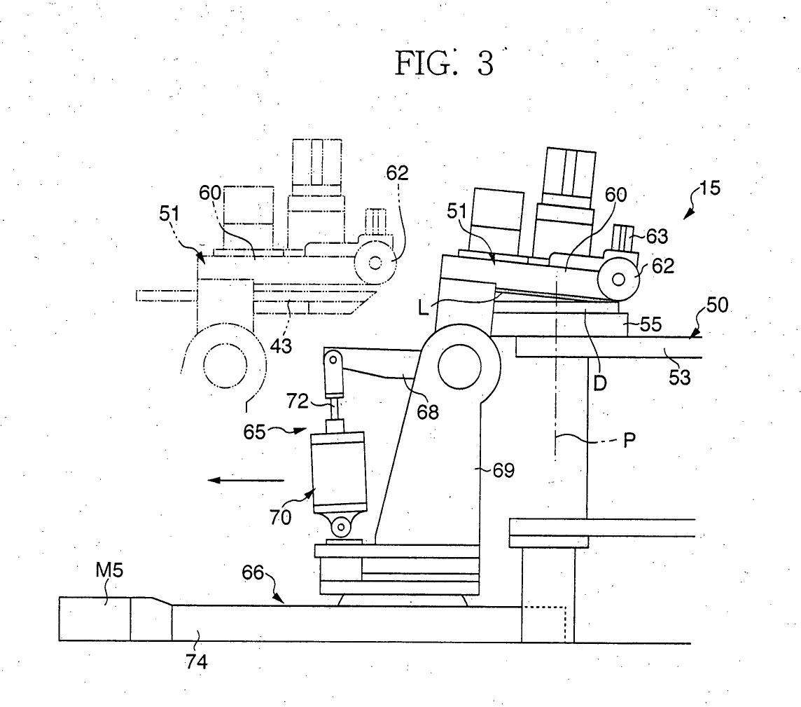

As shown in FIG. 3, the label holding member 51 comprises a suction member 60 provided to suck the protective label L peeled off by the peel plate 43 from the upper surface side, and a press roller 62, which is disposed at one end side of the suction member 60, in this embodiment, at the side of recording substrate D positioned at the laminating center position P, of which predetermined pressing force is adjustable by a cylinder 63. The label holding member 51 is supported by a posture changing means 65 capable of changing the position of the suction member 60 between an approximately horizontal position and an inclined position, and the posture changing means 65 is provided movably in the right and left direction in FIG. 3 via a traveling means 66.

Further, the label holding member 51 is provided with a lot of vacuum holes (not shown) at the lower surface side of the suction member 60, and is arranged to move in the right direction in FIG. 3 corresponding to the traveling speed of the protective label L. In the surface of the suction member 60 also, a centering hole (not shown) is formed, and it is arranged so as to suck the protective label L being centered at the lower surface side of the suction member 60 by a chuck which comes out and retracts inside the centering hole. Here, it is previously arranged so that the right end of the protective label L is positioned at a point where it reaches to lower periphery surface shown in FIG. 3 of the press roller 62. And it is arranged so that, when the label holding member 51 is made to move over the recording substrate D at the laminating center position P by the traveling means 66, it changes the posture via the posture changing means 65 into the inclined state that the press roller 62 side comes to the lower position.

The posture changing means 65 comprises an almost L-shape bracket 68 attached to the both side ends of the suction member 60 in the direction perpendicular to the FIG. 3, a bearing 69 rotatably supporting the bracket 68, and a cylinder unit 70 connected to the front end of the bracket 68. The cylinder unit 70 is arranged so that a rod 72 thereof is movable to come out and retract vertically and, when the rod 72 is at the retraction end, the suction surface of the suction member 60 is kept in the approximately horizontal posture; while, when the rod 72 proceeds upward, the suction member 60 is changed into the inclined posture.

The traveling means 66 comprises a motor M5 capable of normally and reversely rotating, and a feeder unit 74 constituted of a feed screw and the like fixed to the output shaft of the motor M5, and the lower portion of the bearing 69 is screw-engaged with the feeder unit 74; thereby the posture changing means 65 and the label holding member 51 can be moved in the right and left direction in FIG. 3.

As shown in FIG. 4, disposed adjacent to the stage 50 is a robot 76 that supplies and discharges recording substrates D. Arms 77 of the robot 76 are provided rotatably within an approximately horizontal plane and are movable vertically. The arms 77, of which front lower surface is a suction surface, are provided capable of rotating between a stocker 79 disposed outside the frame FL and the stage 50. The stocker 79 comprises a first stock section 79A for holding recording substrates D before being applied with protective label L, and a second stock section 79B for holding recording substrates D2 applied with protective label L in a piled-up state in order. Each of the stock sections 79A and 79B includes a carrier base (not shown) capable of moving vertically, and it is arranged so that recording substrates D and D2 are piled up on the carrier base respectively.

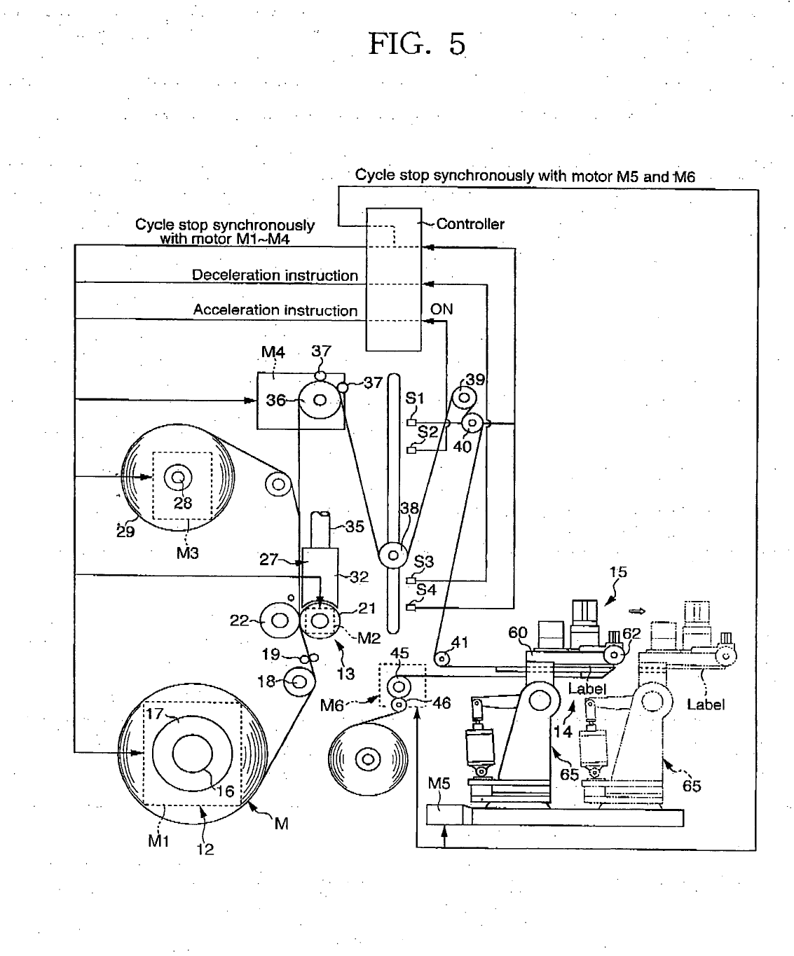

As shown in FIG. 5, the laminating apparatus includes a configuration in which the movement of the strip material M and the rotation of the pre-cutting means 13 is motivated by a motor M2. A dancer roller 38 is disposed between the pre-cutting means 13 and the peeling means 14 and the dancer roller 38 presses on the strip material M and removes slack therefrom.

Because the dancer roller 38 is able to rise or fall depending on the available slack in the strip material M, the dancer roller 38 is provided nearby with sensors that determine the relative position (height) of the dancer roller 38.

With a preferred embodiment, the dancer roller 38 is provided with an upper middle sensor S2 and a lower middle sensor S3 in addition to an upper limit sensor S1 and a lower limit sensor S4.

The sensors (S1, S2, S3, S4) are electronically linked to a motor controller [controller] for controlling at least the motor M2. The motor controller controls the speed of the motor M2 in relation to the sensed vertical position of the dancer roller, as described hereinbelow.

The motor controller for the motor M2 may be any suitable controller, including analog or digital controller. The controller may be electrically connected to the motor M2, or may be in communication with the motor M2 via a wireless connection. Similarly, the motor controller may be electrically connected to the sensors, or may be in communication with the sensor via a wireless connection.

The controller can control not just the condition of the motor M2 (on or off), but also the relative speed of the motor M2. That is, the controller can accelerate the motor M2 from its current running speed to a higher speed, or decelerate it from its current running speed to a lower speed.

In a preferred arrangement, when the upper middle sensor S2 detects the presence of the dancer roller 38, the controller increases the speed of the motor M2; and wherein when the lower middle sensor S3 detects the presence of the dancer roller 38, the controller decreases the speed of the motor M2. Therefore, the laminating apparatus maintains the position of the dancer roller 38 near a middle position.

In a further embodiment, the controller not only controls the motor M2, but also controls any or all of the motors M1, M3, M4, M5 or M6. Its control over these motors may have accelerating and decelerating control similar to its control over motor M2, but its control over motors M1, M3, M4, M5 or M6 may be as simple as on/off.

Next, the entire operation in the embodiment will be described below.

First of all, a specific amount of strip material M, which is wound into a roll-like shape, is pulled out. On the half way, the base sheet S and the film F are peeled manually. The lead end of the base sheet S is fixed to the winding drum 47, and the lead end of the film F is fixed to the winding drum 29 of the first collection unit 26 in the collecting means 25. Thus, the initial setting is completed.

Next, by turning on a predetermined power supply, the motor M4 of the drive roller 36 is driven to feed out the strip material M. Here, the motor M1 of the feeding means 12 is adapted to provide a predetermined feeding resistance so that the strip material M is fed out while keeping a predetermined tension at a level where the plane shape of the protective label L is maintained. The fed out strip material M is formed with an outer cut L1 and an inner cut L2 corresponding to the shape of the recording substrate D while passing through the pre-cutting means 13. To the inner film area F2 in the inner cut L2, air is blown from the nozzle holes 31A of the pipe-like member 31, and the inner film area F2 is sucked into the suction hole 34A of the box member 34 to form a cut part in the center of the label. At the almost same time, the outer film area F1 is wound by the winding drum 29 to form the protective label L being left on the base sheet S.

The protective label L thus formed is, while being peeled off from the base sheet S at the front end of the peel plate 43, sucked and held by the suction member 60 of the label holding member 51. That is, a sensor (not shown) detects timing when the front end (lead end) in the feed direction of the protective label L is positioned immediately under the substantially central axis of the press roller 62. At the same time, the traveling means 66 is actuated to move the label holding member 51 rightward in FIG. 1 at the same speed as the feed speed of the protective label L; and the protective label L peeled sequentially from the front end position of the peel plate 43 is sucked and held by the suction surface of the suction member 60. At the same time, on the stage 50 of the label laminating means 15, recording substrates D are disposed in the state being centered on each holding table 55, and one recording substrate D waits at the laminating center position P.

Then, when the label holding member 51 has reached the position, which is drawn with solid lines in FIG. 3, it is made to change its posture into the inclined posture by the posture changing means 65 so that the press roller 62 comes to the lower position. At this time, the right end of the protective label L coincides with the predetermined lamination start position with respect to the recording substrate D. When the label holding member 51 moves toward leftward in FIG. 3, the press roller 62 rotates on the recording substrate D while maintaining a predetermined pressure force by means of the cylinder 63; thus, the protective label L is transferred from the suction member 60 onto the recording substrate D. At this time, since the label holding member 51 is in the inclined state, air existing between the protective label L and the recording substrate D is expelled therefrom toward the traveling direction of the label holding member 51. Accordingly, the air is prevented from being caught between the laminated surfaces. When the protective label L is laminated onto the recording substrate D at the laminating center position P of the stage 50 as described above, the stage 50 turns approximately 90 degrees in the clockwise direction, and the next recording substrate D waits at the laminating center position P. The laminated recording substrate D2 is transferred to a second stock section 79B of the stocker 79 by the robot 76 and piled up in order. And the robot 76 takes a recording substrate D before lamination out of a first stock section 79A and transfers it onto the holding table 55.

After that, by repeating the same operation, the protective label L can be laminated onto the recording substrate D in order.

Consequently, according to such the embodiment, the protective label L can be laminated onto the recording substrate D immediately after the protective label L is formed in the process of feeding of the strip material M to obtain the effect of sweeping away conventional causes such that the surface accuracy of the protective label L is decreased. Furthermore, since the formation and lamination of the protective label L can be achieved in a sequential operation using the laminating apparatus 10 as a single unit, the manufacturing efficiency is greatly improved compared to the conventional system in which the formation and lamination of the protective label L are performed separately.

As noted above, the dancer roller 38 is electronically linked with the motor M2 for driving the die-cut roll 1 of the pre-cutting means. As an effect of this arrangement, even if the peeling means 14 and or the label laminating means 15 disposed at the downstream side of the dancer roller 38 are stopped suddenly, the die-cut roll 21 forms cuts L1 and L2 without being stopped suddenly. Only after forming the cuts does the die-cut roll stop at a position between labels where no cut is required, while the dancer roller 38 may move physically upward to take up slack of the roll.

With a preferred embodiment, the dancer roller 38 is provided with an upper middle sensor S2 and a lower middle sensor S3 in addition to an upper limit sensor S1 and a lower limit sensor S4, wherein when the upper middle sensor S2 detects the presence of the dancer roller 38, the controller increases the speed of the motor M2; and wherein when the lower middle sensor S3 detects the presence of the dancer roller 38, the controller decreases the speed of the motor M2.

The position of the dancer roller 38 is sensed by the sensors (S1, S2, S3, S4), and the speed of the motor M2 for driving the die-cut roll 21 of the pre-cutting means is adjusted accordingly by the controller. In other words, the motor M2 is controlled in response to the vertical position of the dancer roller 38.

When the upper limit sensor S1 or the lower limit sensor S4 detects the dancer roller 38, the controller directs that the feed-out operations of the strip material M, the cut forming operation and like are “cycle stopped”. When the upper middle sensor S2 detects the dancer roller 38, the controller increases the rotation of the motor M2 (accelerating control) and the dancer roller 38 descends gradually. However, there is a possibility that some problem occurs at some point of the apparatus, and irrespective of the accelerating control, the dancer roller further ascends to be detected by the upper limit sensor S1. In that case, the upper limit sensor signals the controller that the dancer roller 38 is approaching, and the controller issues a cycle stop to some or all motors.

If a stop is made while the motor M2 is driven to rotate and form a cut in a film, or while the motor M5 is driven to rotate and cause a label to be received with the suction member 60, a problem may occur when restoring the operation. Therefore, the wording “cycle stop” means a stopping mode of operation in which the apparatus is stopped after the above operations have been completed. The operation of the controller in response to signals from the lower middle sensor S3 and the lower limit sensor S4 (decelerating operation) is similar to the above-described operation of the controller in response to signals from upper middle sensor S2 and the upper limit sensor S1.

When a “cycle stop” is made, it is determined that an abnormal condition has occurred. Therefore, initializing operation including a positioning of the dancer roller and the like necessary for restoring operation may have to be made by an operator before restarting the operation.

As described above, the best structure, manner and the like for carrying out the invention have been disclosed. However, the invention is not limited to that.

That is to say, the invention has been specifically shown diagrammatically and described concerning mainly a few particular embodiments. It is possible, however, for a person in the art to add various modifications concerning configuration, location, layout or the like to the embodiment described above without departing from the technical idea and purpose of the invention. For example, in the above embodiment, a pipe-like member 31 or the like is used as a blowing means. However, it is possible to adopt such structure in which the inner film area F2 is removed using an appropriate push-out rod or the like. Further, the label laminating means 15 is not limited to that shown in the drawings or examples of the structure, but those provided with a variety of structures or mechanisms can be adopted only when protective label L can be laminated onto the recording substrate D.

In a word, the invention can be achieved only when the protective label L can be formed and laminated in a sequential operation, while eliminating the separated manufacturing process causing a decrease of a surface accuracy.

As described above, the invention can provide a laminating apparatus having an excellent effect, which was conventionally not found, of capable of laminating a protective label onto a recording substrate while maintaining the accuracy thereof in a high level.

We claim:

1. A laminating apparatus for laminating a label on an information recording disk substrate comprising:
a feeding means for feeding a strip material including a film for forming a label on a base sheet,
a pre-cutting means for forming a label by making cuts on said film in accordance with the plane shape of said recording substrate,
a peeling means for peeling said label from the base sheet, and
a label laminating means for laminating the peeled label to said recording substrate;
wherein said strip material traverses from said pre-cutting means through said peeling means to said label laminating means;
wherein said pre-cutting means is motivated by a first motor;
wherein said feeding means includes a second motor for feeding said strip material, and
wherein said second motor of said feeding means is adapted to provide a predetermined feeding resistance so that said strip material is fed out while keeping a predetermined tension at a level such that the plane shape of the protective label thereon is maintained;
said apparatus further comprising:
a dancer roller providing tension on said strip material between said pre-cutting means and said peeling means, said dancer roller displaceable between an upper limit and a lower limit but defaulting to a middle position between said upper limit and said lower limit;
at least one sensor for sensing the location of said dancer roller relative to said middle position, said upper limit and said lower limit;
a controller for controlling said motor, said controller responsive to input from said sensors;
wherein said controller slows said first motor when said dancer roller is between said middle position and said lower limit, and said controller increases the speed of said first motor when said dancer roller is between said middle position and said upper limit.

2. The laminating apparatus according to claim 1, wherein said at least one sensor comprises
an upper limit sensor that senses if said dancer roller is adjacent to said upper limit, and
a lower limit sensor that senses if said dancer roller is adjacent to said lower limit.

3. The laminating apparatus according to claim 2, wherein said at least one sensor further comprises
an upper middle sensor that senses if said dancer roller is between said middle position and said upper limit, and
a lower middle sensor that senses if said dancer roller is between said middle position and said lower limit.

4. The laminating apparatus according to claim 3, wherein said controller stops said first motor when said dancer roller is sensed by either said upper limit sensor or said lower limit sensor.

5. The laminating apparatus according to claim 4, wherein said controller also controls said second motor.

6. The laminating apparatus according to claim 5, further comprising a collecting means for collecting the film area excluding said label.

7. The laminating apparatus according to claim 6, wherein said collecting means comprises a first collection unit for collecting an outer film area positioned at the outer side of the label, and a second collection unit for collecting an inner film area formed at the central area of the label.

8. The laminating apparatus according to claim 7, wherein said second collection unit comprises a blowing means for blowing air to said inner film area, and a suction means for sucking said inner film area positioned at the opposite side of the blowing means.

9. The laminating apparatus of claim 1, wherein said label laminating means comprises a stage that supplies said recording substrate to a predetermined laminating position, a label holding member that is provided movably with respect to the recording substrate at said laminating position and holds said label, and a pressing member that gives a predetermined pressing force to the label overlapped over the recording layer surface of said recording substrate by relative movement between the recording substrate and the label holding member.

10. The laminating apparatus of claim 2, wherein said label laminating means comprises a stage that supplies said recording substrate to a predetermined laminating position, a label holding member that is provided movably with respect to the recording substrate at said laminating position and holds said label, and a pressing member that gives a predetermined pressing force to the label overlapped over the recording layer surface of said recording substrate by relative movement between the recording substrate and the label holding member.

11. The laminating apparatus of claim 3, wherein said label laminating means comprises a stage that supplies said recording substrate to a predetermined laminating position, a label holding member that is provided movably with respect to the recording substrate at said laminating position and holds said label, and a pressing member that gives a predetermined pressing force to the label overlapped over the recording layer surface of said recording substrate by relative movement between the recording substrate and the label holding member.

12. The laminating apparatus of claim 4, wherein said label laminating means comprises a stage that supplies said recording substrate to a predetermined laminating position, a label holding member that is provided movably with respect to the recording substrate at said laminating position and holds said label, and a pressing member that gives a predetermined pressing force to the label overlapped over the recording layer surface of said recording substrate by relative movement between the recording substrate and the label holding member.

13. The laminating apparatus according to claim 9, wherein said label holding member is provided so as to perform a relative movement with respect to the surface of the recording substrate while holding said label in an inclined posture with respect to the surface of the recording substrate, and said pressing member presses the label while moving from one end to the another end thereof to laminate the label onto the recording substrate gradually.

14. The laminating apparatus according to claim 10, wherein said label holding member is provided so as to perform a relative movement with respect to the surface of the recording substrate while holding said label in an inclined posture with respect to the surface of the recording substrate, and said pressing member presses the label while moving from one end to the another end thereof to laminate the label onto the recording substrate gradually.

15. The laminating apparatus according to claim 11, wherein said label holding member is provided so as to perform a relative movement with respect to the surface of the recording substrate while holding said label in an inclined posture with respect to the surface of the recording substrate, and said pressing member presses the label while moving from one end to the another end thereof to laminate the label onto the recording substrate gradually.

16. The laminating apparatus according to claim 12, wherein said label holding member is provided so as to perform a relative movement with respect to the surface of the recording substrate while holding said label in an inclined posture with respect to the surface of the recording substrate, and said pressing member presses the label while moving from one end to the another end thereof to laminate the label onto the recording substrate gradually.

17. The laminating apparatus according to claim 13, wherein said pressing member comprises a press roller capable of rotating on said label.

18. The laminating apparatus according to claim 14, wherein said pressing member comprises a press roller capable of rotating on said label.

19. The laminating apparatus according to claim 15, wherein said pressing member comprises a press roller capable of rotating on said label.

20. The laminating apparatus according to claim 16, wherein said pressing member comprises a press roller capable of rotating on said label.
